(19) United States
(12) Patent Application Publication
(10) Pub. No.: US 2010/0082146 A1
(43) Pub. Date: Apr. 1, 2010

(54) SIMULATION OR MODELING METHOD OF CUTTING, PROGRAM OF THAT METHOD, AND MEDIUM RECORDING THAT PROGRAM

(76) Inventor: Masaki Sato, Tokyo (JP)

Correspondence Address: DAY PITNEY LLP, 7 TIMES SQUARE, NEW YORK, NY, 10036-7311, US

(21) Appl. No.: 12/449,805

(22) PCT Filed: Apr. 21, 2008
(86) PCT No.: PCT/JP2008/057681

§ 371 Date: Aug. 27, 2009

(30) Foreign Application Priority Data
May 17, 2007 (JP) 2007-131224

(51) Int. Cl. G05B 19/4069; G05B 19/4097

(52) U.S. Cl. 700/118; 345/424

(57) ABSTRACT

The present invention relates to a simulation method of cutting processing, a program for the simulation method of cutting processing, a recording medium recording the program for the simulation method of cutting processing, a modeling method, a program for the modeling method, and a recording medium recording the program for the modeling method, and is made so as to enable representation even of undercut portions and the like, and to enable smooth representation of a work form using simplified processing. The present invention represents a work and a target of processing by sequentially dividing a voxel into a set of voxels, and represents a voxel that changes in form using polygons.

### TECHNICAL FIELD

It is possible to apply the present invention to, for example, simulation of cutting processing and modeling of a three-dimensional form. The present invention is made so as sequentially to divide voxels and represent a work or an object of processing as a set of voxels, and can represent even an undercut portion by representing voxels that change in form, according to progress of cutting processing or according to user operation, with polygons, whereby it is possible to represent a form of a work smoothly using simplified processing.

### BACKGROUND ART

Conventionally, in a die manufacturing process, after creating form data indicating an external form of a working target using CAD/CAM, for example by applying the technique disclosed in Japanese Unexamined Patent Application Publication No. H8-123526, data of a tool locus indicating a tool locus at a time of die processing can be created, and from this tool locus data, NC data driving an NC device for cutting machining is created. In this series of processing, during a die manufacturing process, a form of a work changing as a result of cutting machining is displayed by way of cutting machining simulation, whereby it is possible to confirm the cutting process in advance.

Here, in the cutting processing simulation, conventionally, such methods as a Z-map method, a B-Reps method, and a voxel modeling method have been used. Here, the Z-map method is a method of generating a work form during processing, based on form data of a working target and tool locus data, at each point of cutting processing for each pair of X and Y coordinates, by detecting a coordinate with the largest value on the Z axis from the Z coordinates of the working target and the tool tip. On the other hand, the B-Reps method is a method of representing work at each point in cutting processing by polygons based on form data of a working target and tool locus data. The voxel modeling method is a method of representing a work by a set of voxels, which are blocks of cubic form.

Of these methods, the Z-map method has a problem in that representing an undercut portion, a face flat on the Z axis, or the like is difficult. On the other hand, in the B-Reps method and the voxel modeling method, these problems with the Z-map method are solved. However, with the B-Reps method, there is the problem in that excessive arithmetic processing is necessary in the generation of polygons. On the other hand, in the voxel modeling method, there is the problem that, while processing is simplified, a work form cannot be represented smoothly.

[Patent Publication 1] Japanese Unexamined Patent Application Publication No. H8-123526

### DISCLOSURE OF THE INVENTION

### Problems to be Solved by the Invention

The present invention was created in consideration of the above-mentioned points, in order to enable representation even of undercut portions and the like using simplified processing, by providing a simulation method, a program for the simulation method, and a recording medium recording the program for the simulation method for cutting processing; and a modeling method, a program for the modeling method, and a recording medium recording the program for the modeling method using this technique, capable of smoothly representing a work form.

### Means for Solving the Problems

In order to solve the above-mentioned problem, the invention according to a first aspect applies a simulation method of cutting processing that displays a form of a work sequentially changing by cutting processing based on data of a tool locus, cyclically repeating in sequence a step of tool movement, a step of voxel division, a step of voxel removal, a step of polygonization, and a step of displaying. The tool movement step is a step of moving a tool only a predetermined distance relative to a work represented by voxels, or a work represented by voxels and polygons, based on the data of the tool locus. The voxel division step is a step of moving a tool according to the tool movement step, and representing the work as a set of voxels before division and divided voxels, or as a set of voxels before division and divided voxels and polygons by dividing voxels that interfere with the tool. The voxel removal step detects and removes voxels and polygons cut and removed by movement of the tool in the tool movement step from a work in which voxels were divided in the voxel division step. The step of polygonization is a step of detecting voxels and polygons cut by the tool movement in the tool movement step from a work of voxels and polygons which remain from the voxel removal step, and replacing a form of the detected voxels and polygons after being cut in the tool movement step to be represented with polygons. The display step is a step of displaying a work according to the voxels and polygons.

Furthermore, the invention according to a third aspect applies to a program of a simulation method of cutting processing displaying a form of a work sequentially changing by cutting processing based on data of a tool locus, and includes cyclically repeating in sequence a step of tool movement, a step of voxel division, a step of voxel removal, a step of polygonization, and a step of display. The tool movement step is a step moving a tool only a predetermined distance relative to a work represented by voxels, or a work represented by voxels and polygons based on the data of the tool locus. The voxel division step moves a tool according to the tool movement step, and represents the work as a set of voxels before division and divided voxels, or as a set of voxels before division and divided voxels and polygons by dividing voxels interfering with the tool. The voxel removal step detects and removes voxels and polygons cut and removed by movement of the tool in the tool movement step from a work in which voxels were divided in the voxel division step. The step of polygonization detects voxels and polygons cut by the tool movement in the tool movement step from a work of voxels and polygons which remain from the voxel removal step, and replaces a form of the detected voxels and polygons after being cut in the tool movement step to be represented with polygons. The display step displays a work according to the voxels and polygons.

In addition, in the invention according to a fourth aspect, the program of the simulation method applies to a recording medium recording the program for the simulation method of cutting processing that displays a form of a work sequentially changing by cutting processing based on data of a tool locus, and includes cyclically repeating in sequence a step of tool movement, a step of voxel division, a step of voxel removal, a step of polygonization, and a step of display. The tool movement step is a step of moving a tool only a predetermined distance relative to a work represented by voxels, or a work represented by voxels and polygons, based on the data of the tool locus. The voxel division step moves a tool according to the tool movement step, and represents the work as a set of voxels before division and divided voxels, or as a set of voxels before division and divided voxels and polygons, by dividing voxels interfering with the tool. The voxel removal step detects and removes voxels and polygons cut and removed by movement of the tool in the tool movement step from a work in which voxels were divided in the voxel division step. The step of polygonization detects voxels and polygons cut by the tool movement in the tool movement step from a work of voxels and polygons which remain from the voxel removal step, and replaces a form of the detected voxels and polygons after being cut in the tool movement step to be represented with polygons. The display step displays a work according to the voxels and polygons.

Furthermore, the invention according to a fifth aspect is actuated by an operation of a user, applies a modeling method creating a three-dimensional object form, and according to an initialization step, accepts an input of a form of a work target, represents the work target by voxels, or represents the work target by voxels and polygons, and then cyclically repeats in sequence a step of input acceptance, a step of voxel division, a step of voxel removal, and a step of polygonization. The input acceptance step is actuated by an operation of the user and accepts a change of form of the work target. The voxel division step divides the voxels of a portion related to the change caused by a change in form of the target object in the input acceptance step, and represents the work object as a set of voxels before division and divided voxels, or as a set of voxels before division and divided voxels and polygons. The voxel removal step detects and removes voxels and polygons which have become unnecessary by a change in form of the work object in the input acceptance step, from the work object in which voxels were divided in the voxel division step. The step of polygonization detects voxels and polygons deformed in form by a change in form of the target object in the input acceptance step, from a work object of voxels and polygons which remain from the voxel removal step, and replaces the changed form of the voxels and polygons deformed in form to be represented by polygons.

Also, the invention according to a sixth aspect applies to a program of a modeling method creating a three-dimensional object form upon actuation by an operation of a user, and according to an initialization step; accepts an input of a form of a work object, represents the target object as voxels or represents the target object as voxels and polygons, and includes cyclically repeating in sequence a step of input acceptance, a step of voxel division, a step of voxel removal, and a step of polygonization. The input acceptance step is actuated by an operation of the user and accepts a change of form of the work target. The voxel division step divides the voxels of a portion related to the change caused by a change in form of the target object in the input acceptance step, and represents the work object as a set of voxels before division and divided voxels, or as a set of voxels before division and divided voxels and polygons. The voxel removal step detects and removes voxels and polygons which have become unnecessary by a change in form of the work object in the input acceptance step, from the work object in which voxels were divided in the voxel division step. The step of polygonization detects voxels and polygons deformed in form by a change in form of the target object in the input acceptance step, from a work object of voxels and polygons remaining from the voxel removal step, and replaces the changed form of the voxels and polygons deformed in form to be represented as polygons.

In addition, in the invention according to a seventh aspect, the program of the modeling method applies to a recording medium recording the program for the modeling method creating a three-dimensional object form upon actuation by an operation of a user, and according to an initialization step, accepts an input of a form of a work object, represents the target object as voxels or represents the target object as voxels and polygons, and includes cyclically repeating in sequence a step of input acceptance, a step of voxel division, a step of voxel removal, and a step of polygonization. The input acceptance step is actuated by an operation of the user and accepts a change of form of the work target. The voxel division step divides the voxels of a portion related to the change caused by a change in form of the target object in the input acceptance step, and represents the work object as a set of voxels before division and divided voxels, or as a set of voxels before division and divided voxels and polygons. The voxel removal step detects and removes voxels and polygons which have become unnecessary by a change in form of the work object in the input acceptance step, from the work object in which voxels were divided in the voxel division step. The step of polygonization detects voxels and polygons deformed in form by a change in form of the target object in the input acceptance step, from a work object of voxels and polygons which remain from the voxel removal step, and replaces the changed form of the voxels and polygons deformed in form to be represented as polygons.

According to the configuration of any one of the first or third to fourth aspects, by cyclically repeating in sequence a step of tool movement, a step of voxel division, a step of voxel removal, a step of polygonization, and a step of display, it is possible sequentially to divide voxels and suitably to remove thereof by progression in cutting processing, and to display a form of a work at each point in cutting processing. Therefore, it is possible to represent even undercut portions and the like, and to display a simulated image of cutting processing by simplified arithmetic processing. Furthermore, in this series of processing, it is possible smoothly to represent a work form by representing a form processed by cutting processing as polygons according to the step of polygonization.

In addition, according to the configuration of the fifth to seventh aspects, it is possible to represent even undercut portions and the like, and sequentially to represent a form of a target object by cyclically repeating in sequence a step of voxel division, a step of voxel removal, and a step of polygonization. Furthermore, in this series of processing, by representing a form processed by cutting processing as polygons according to the step of polygonization, it is possible smoothly to represent a work form.

### EFFECTS OF THE INVENTION

According to the present invention, it is possible to represent even undercut portions and the like, and therefore, a work form can be smoothly represented by simplified processing. In addition, a modeling method, program for the modeling method, and recording medium recording the program for the modeling method using this technique can be provided.

### BRIEF DESCRIPTION OF THE DRAWINGS

FIG. 1 is a flowchart showing a processing procedure of a computer in this simulation of cutting processing according to a first embodiment of the present invention;

FIG. 2 is a block diagram showing a CAM system according to a first embodiment of the present invention;

FIG. 3 is a schematic diagram showing the initialization of the procedure in FIG. 1;

FIG. 4 is a schematic diagram showing for voxel division of the procedure in FIG. 1;

FIG. 5 is a schematic diagram showing the continuous procedure in FIG. 5;

FIG. 6 is a schematic diagram showing for polygonization of the procedure in FIG. 1; and

FIG. 7 is a schematic diagram showing a example of work.

### PREFERRED MODE FOR CARRYING OUT THE INVENTION

Hereinafter, embodiments of the present invention are described in detail with reference to the diagrams where suitable.

### First Embodiment

### (1) Configuration of the Embodiment

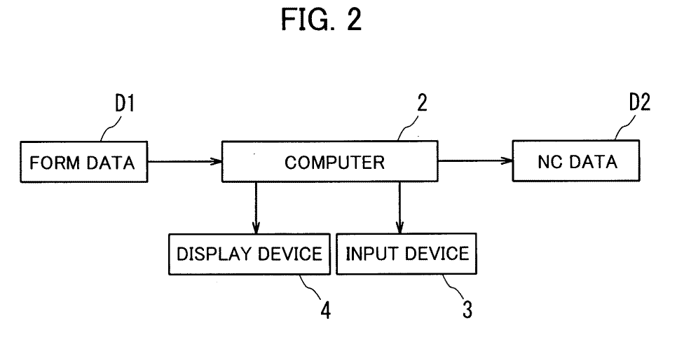

FIG. 2 is a block diagram showing a CAM system according to a first embodiment of the present invention. On this CAM system 1, form data D1 of a working target are created by a CAD system, not shown, and these form data D1 are provided to a computer 2 online or through various recording media. It should be noted that there are also cases in which the form data D1 are created using the computer 2 constituting this CAM system.

According to an instruction of an operator using an input device 3 such as a keyboard or mouse, the computer 2 executes a predetermined program, whereby a form of a working target according to these form data D1 is displayed on a display device 4. Furthermore, based on these form data 1 and tools designated by the operator, for example, data of a tool locus of contour cutting processing are created. In addition, a simulation of cutting processing according to the created data of the tool locus is executed, and a work form that successively changes as a result of cutting processing is displayed on the display device 4. Furthermore, according to these created data of the tool locus, NC data D2, which are control data of the cutting processing device, are created and output.

It should be noted that, while the program for this computer 2 is recorded and provided on various recording media such as an optical disc, it can be provided by downloading through a network such as the Internet, and can additionally be provided by installation beforehand on the computer 2.

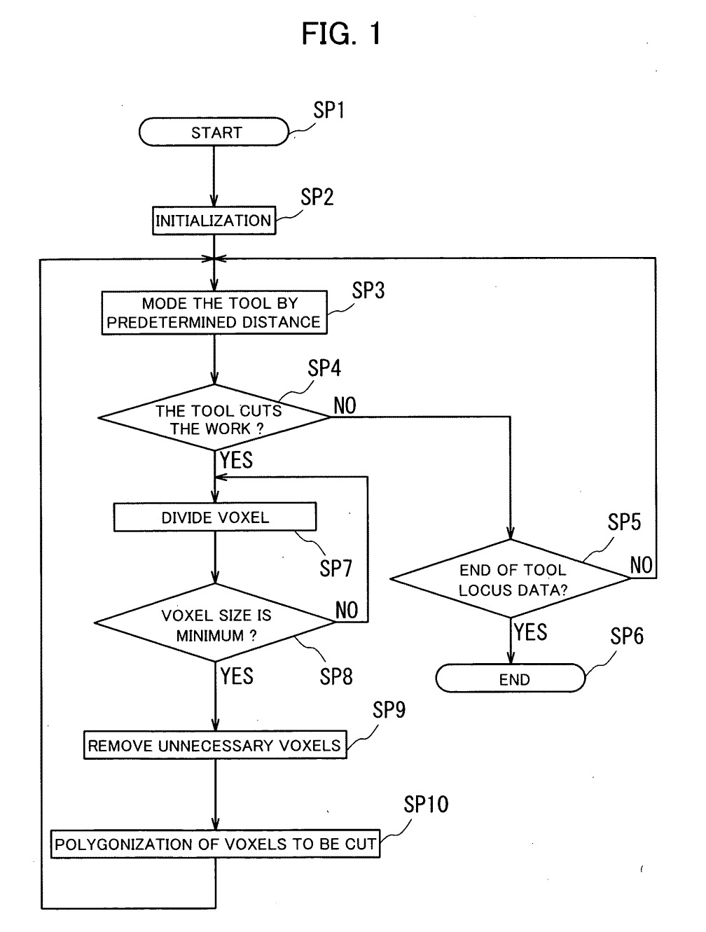

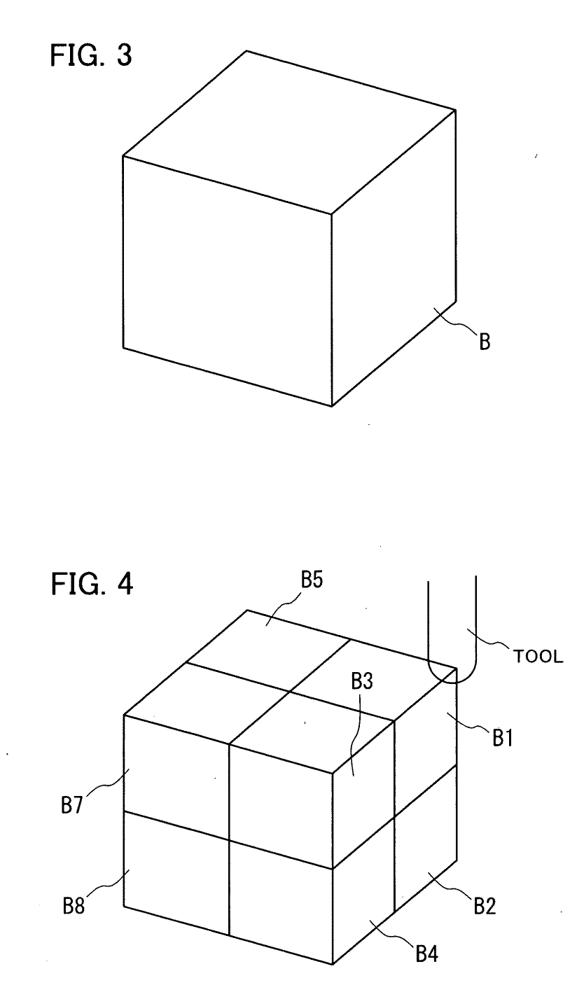

FIG. 1 is a flowchart showing a processing procedure of the computer 2 in this simulation of cutting processing. When the operator instructs simulation of cutting processing, the computer 2 begins this processing procedure and transitions from Step SP1 to Step SP2. Here, the computer 2 performs initialization processing, obtains coordinate data of each vertex defining a voxel from data of cutting processing conditions associated with data of a tool locus, and thereby represents a work for cutting processing as one voxel B, as shown in FIG. 3. It should be noted that these data of cutting processing conditions are such data as work size, type of tool applied to cutting processing, and tool radius. The computer 2 performs rendering processing on this voxel B according to a perspective, light source, and the like specified by the operator, and displays thereof on the display device 4. Furthermore, the computer 2 accepts input of a minimum size of a voxel to divide and generate according to this initialization processing. It should be noted that this minimum voxel size can be automatically created from data of a tool locus. More specifically, as a method for automatic creation, for example, in a case of data of a tool locus being data of contour cutting processing, a case in which the pitch of the z-axis direction of this contour is set to be a length of one side or the like can be considered.

Next, the computer 2 transitions to Step SP3, and here, based on data of a tool locus, moves the tool a predetermined distance for the work generated in Step SP2. Furthermore, in the following Step SP4, it is determined whether the tool has cut the work according to movement of the tool in Step SP3. It should be noted that this determination method can be applied to various determination methods for tool interference.

Here, if a negative result is obtained in Step SP4, the computer 2 transitions from Step SP4 to Step SP5, determines data of a tool locus, and determines whether the simulation of cutting processing has completed. Here, if a negative result is obtained, the computer 2 returns from Step SP5 to Step SP3, and on the other hand, if a positive result is obtained in Step SP5, transitions from Step SP5 to Step SP6, and completes this processing procedure.

As a result, the computer 2 moves the tool a predetermined distance at each time based on data of the tool locus, and repeats a determination of whether to cut the work. It should be noted here that, this predetermined distance can be, for example, set by input of an operator, or that a grid-point set on a work as a length of one side of a minimum voxel, according to initialization settings of Step SP2, can be set as a unit thereof.

Here, if a positive result is obtained in Step S4, the computer 2 transitions from Step SP4 to Step SP7. Here, the computer 2 partitions voxels of a point which the tool cuts into two in each coordinate direction. Therefore, for example, as shown in FIG. 4 by comparison with FIG. 3, in a case in which only one voxel B has been set by initialization, the computer 2 partitions this one voxel B equally in each of the directions X, Y, and Z, and generates eight voxels B1 to B8.

Next, the computer 2 transitions from Step SP7 to Step SP8, and according to a similar determination technique as in Step SP4, detects the voxel to be cut by a tool from among the voxels B1 to B8 generated in Step SP7. It should be noted here that, in the example of FIG. 4, voxel B1 has been detected as the voxel to be cut by the tool. The computer 2 determines whether this detected voxel B1 is of the minimum size set at the initialization processing of Step SP2, and if a negative result is obtained here, returns to Step SP7.

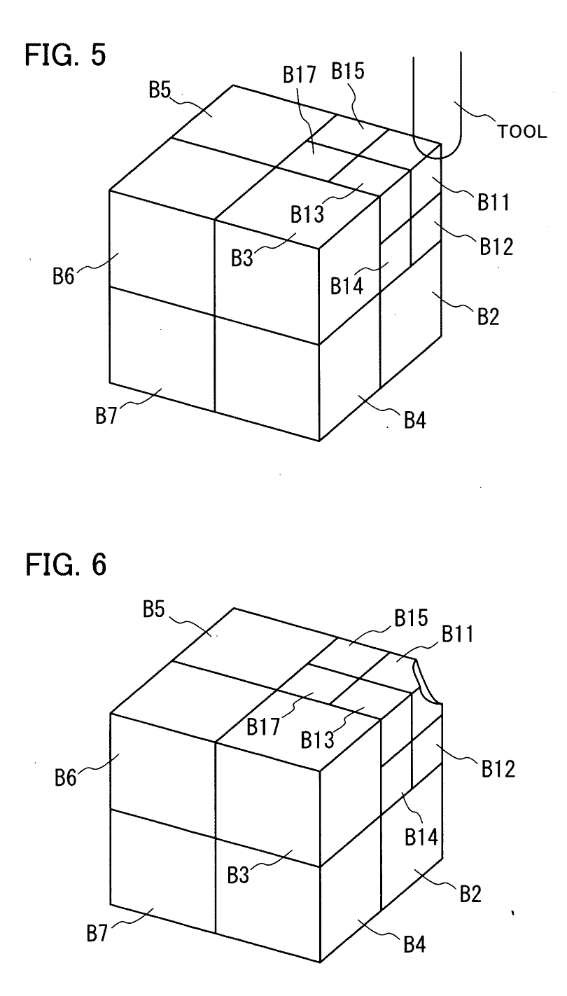

As a result, the computer 2, as shown in FIG. 5, further equally partitions the voxel B1 in contact with the tool in each of the X, Y, and Z directions, generating voxels B11 to B18. The computer 2 sequentially partitions voxels in contact with the tool in this manner, and when a size of a voxel becomes the minimum size set in Step SP2, by obtaining a positive result in Step SP8, transitions to Step SP9.

Here, the computer 2 sets a voxel that has become of minimum size as a result of processing of the immediately prior Step SP7 as a target of processing, detects voxels to be cut and removed by movement of a tool in Step SP3 from voxels of the target of processing, and removes these detected voxels from the work. Furthermore, in the following Step SP10, voxels to be cut by the tool are detected from among the remaining voxels of the target of processing. In addition, as shown in FIG. 6, by comparison with FIG. 5, the form after cutting of this detected voxel B11 is replaced to be represented by polygons. When representing the form after cutting with these polygons, the computer 2 represents the form after cutting by setting the number of polygons so as to be of sufficient practical smoothness in order to display the work on the display device 4 so as to be visually recognizable. It should be noted that various forms can be applied to polygon figuration.

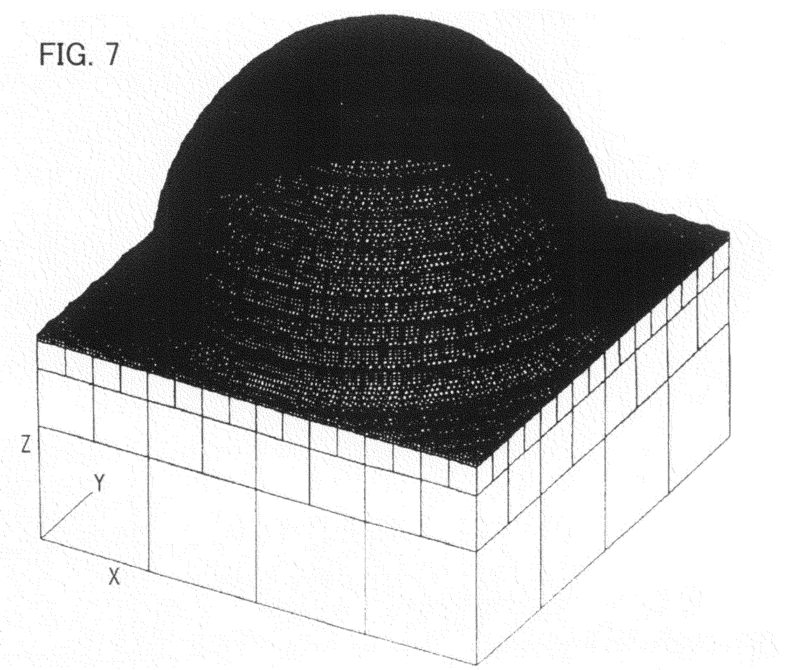

After display on the display device 4 has been switched after performing rendering processing on the form of the work in which a part has been polygonized from a set of voxels as a result of the processing in Step SP10, the computer 2 returns to Step SP3, and the tool is further moved by only a predetermined distance. As a result, while moving the tool by a predetermined distance each time according to data of a tool locus, the computer 2 displays a form of the work at each movement position on the display device 4, and provides a simulated image after cutting to the operator. As a result, the computer 2 represents a work form by voxels and polygons as shown in FIG. 7. It should be noted that this is an example of displaying a work form in a case in which a semispherical form is to be roughly processed by contour cutting processing.

Moreover, as a result of this, in a case of repeating Steps SP9 to SP10 after first setting polygons for a work, the computer 2 sets voxels and polygons as targets of processing, detects and removes polygons and voxels to be cut and removed from the work, as a result of movement of the tool in Step SP3, and replaces a form after cutting to be represented with polygons.

### (2) Operation of the Embodiment

In the above-mentioned configuration, on this CAM system 1, data of a tool locus according to contour cutting processing and the like are created using form data D1 created by CAD, and NC data D2 are created according to these data of the tool locus. When creating these NC data D2, a simulation of cutting processing is performed by the computer 2, and a form of a work sequentially changing as a result of cutting processing is displayed on the display device 4. As a result, in this CAM system 1, before actually performing cutting processing on a work, it is possible to confirm visually a visual aspect of cutting processing beforehand.

In this CAM system 1, regarding this simulation of cutting processing, a work is represented by one voxel, and as a result of sequentially dividing this voxel and sequentially removing voxels to be removed by cutting processing, as with the case of simulation of cutting processing according to the voxel modeling method, it is possible to display a work form even for an undercut portion or a face planar in the z-axis direction using simplified processing.

Furthermore, at this time, a voxel which the tool contacts is detected, and by dividing this voxel, it is possible to limit the number of voxels to divide to a minimum required level. As a result, it is possible to reduce the amount of arithmetic processing and to simplify processing.

However, just by simply sequentially dividing voxels and sequentially removing voxels to be removed as a result of cutting processing, it is not possible to represent smoothly a work form. Therefore, in this CAM system 1, a form after cutting of voxels to be cut as a result of movement of the tool is replaced to be represented by polygons. As a result, in the present embodiment, it is possible to represent a form of a work by voxels and polygons, whereby the work form can be represented smoothly.

### (3) Effects of the Embodiment

According to the above-mentioned configuration, by sequentially dividing voxels and representing a work as a set of voxels, voxels changing in form as a result of cutting processing can be represented by polygons, and thus, by enabling representation even of an undercut portions and the like, it is possible to represent smoothly a work form using simplified processing.

### Second Embodiment

According to the present embodiment, the present invention is applied to machining and finishing processing, and has a work roughly processed according to the technique of the first embodiment as an object thereof. Here, except for the point in which initialization processing differs, the computer of the present embodiment performs processing of a simulation by performing the processing procedure of FIG. 1 similarly to the computer 2 of the first embodiment.

Here, the computer of the present embodiment performs the processing procedure of FIG. 1 according to the start of simulation of this machining and finishing processing. This computer, in the initialization of Step SP2 according to FIG. 1, omits initialization processing for the work, and sets a work represented by polygons and voxels according to the simulation of the first embodiment as a target of processing. In addition, in order to accommodate the tool for machining and finishing processing, a setting for a minimum size of a voxel is accepted, and furthermore, a minimum size for this voxel is automatically set.

According to the present embodiment, it is possible to apply the invention to simulation of machining and finishing processing, and even in a case of a simulation in which a work represented as voxels and polygons is set as a target of processing, a similar effect as that of the first embodiment can be obtained.

### Third Embodiment

According to the present embodiment, a simulation of cutting processing is performed on a work represented by polygons and the like as a target. It should be noted that the work represented by these polygons and the like here, with regard to the background technology described in Background of the Invention, for example, is a display target created by a simulation of the above-described conventional technique.

As a result, the computer according to the present embodiment begins the processing procedure of FIG. 1 upon starting the processing of this simulation. Furthermore, in the initialization processing of Step SP2 of the processing procedure of FIG. 1, a work represented by these polygons and the like is represented by voxels and polygons. In addition, thereafter, the processing procedure of Steps SP3 to SP10 of FIG. 1 is performed sequentially.

Here, processing that represents a work of this target of processing using voxels and polygons is performed by defining one voxel including the work of this target of processing from maximum and minimum values in the X, Y, and Z directions of the work of the target of processing, and thereafter dividing this voxel sequentially and removing unnecessary voxels thereof, and representing voxels divided until the minimum size using polygons.

According to the present embodiment, in initialization processing, by re-representing a work represented by polygons and the like using voxels and polygons, it is possible to obtain a similar effect as that of the first embodiment using data used in processing of various simulations.

### Fourth Embodiment

In the present embodiment, the present invention is applied to modeling processing of a three-dimensional form. That is to say, the computer of the present embodiment is actuated by an operation of the user in accepting input of a size of a target of processing, and creates a voxel according to this size. Furthermore, this computer displays this voxel, and accepts a selection of a tool for cutting processing of the target of processing displayed according to this voxel. It should be noted that, in this case, the target of processing may be represented as voxels and polygons.

Here, in the present embodiment, as a selectable tool, a cutter that cuts the target of processing, and a planar and router that polishes the target of processing and the like are provided. If a user selects a cutting tool, the computer accepts a designation of a cutting place on a display screen. On the other hand, if the user selects the router, the router icon is displayed and, actuated by an operation of a mouse by the user, the computer accepts input of an amount of polishing, portion for polishing, and the like. In addition, if the user selects the planar, similarly, input of a portion for applying the planar and input of an amount of application of the planar by the user are accepted.

Upon accepting input of a processing place, processing amount, or the like from the user in this manner, similarly to that described above in regard to the first embodiment, the computer removes unnecessary voxels while sequentially dividing voxels in accordance with this input, and displays the voxels most divided by representation using polygons. Furthermore, actuated by an operation of the user, the computer repeats this series of processing.

As a result, the computer sequentially changes and displays a form of the target of processing represented by voxels just as in a case of processing the target of processing of a three-dimensional form using a cutter or the like. Furthermore, when the user instructs to revert to the original, the display is reverted to a state previous to processing immediately before.

If the user instructs storage of the form, the computer stores form data according to the three-dimensional form created in this manner, in the format specified by the user.

As in the present embodiment, even if applied to modeling processing of a three-dimensional form, a smooth form can be represented similarly to that in the above-described embodiment.

### Fifth Embodiment

It should be noted that, in the above-described first embodiment, a case of representing a work according to processing of initialization by one voxel is described; however, the present invention is not limited thereto, and may represent a work using a plurality of sets of voxels beforehand as necessary.

Furthermore, in the above-described first embodiment, a case of applying the present invention to simulation of cutting processing in die processing is described; however, the present invention is not limited thereto, and can widely be applied to various simulations of cutting processing.

### INDUSTRIAL APPLICABILITY

The present invention can be applied to a CAM system in application to die processing and the like.

1. A simulation method of cutting processing which displays a form of a work that sequentially changes by cutting processing based on data of a tool locus, the method cyclically repeating in sequence:
a step of tool movement; a step of voxel division; a step of voxel removal; a step of polygonization; and a step of displaying, wherein:
the step of tool movement is
a step in which a tool is moved by only a predetermined distance for a work represented by a voxel, or a work represented by a voxel and a polygon, based on data of the tool locus;
the step of voxel division is
a step in which the work is represented by a set of voxels before division and divided voxels, or by a set of voxels before division and polygons and voxels after division, by moving the tool according to the step of tool movement and dividing a voxel interfering with the tool;
the step of voxel removal is
a step in which voxels and polygons cut and removed by movement of the tool by the step of tool movement are detected and removed from the work wherein voxels were divided in the step of voxel division;
the step of polygonization is
a step in which voxels and polygons cut by movement of the tool in the step of tool movement are detected from a work according to voxels and polygons remaining from the step of voxel removal, and a form of the detected voxels and polygons after cutting according to the step of tool movement is represented and replaced by polygons; and
the step of display is
a step in which the work according to the voxels and the polygons is displayed.

2. The simulation method of cutting processing according to claim 1, comprising:
a step of converting a work represented by predetermined form data into a work represented by the voxel and polygon beforehand.

3. A Program for simulation method of cutting processing which displays a form of a work that sequentially changes by cutting processing based on data of a tool locus, the method cyclically repeating in sequence:
a step of tool movement; a step of voxel division; a step of voxel removal; a step of polygonization; and a step of displaying, wherein:
the step of tool movement is
a step in which a tool is moved by only a predetermined distance for a work represented by a voxel, or a work represented by a voxel and a polygon, based on data of the tool locus;
the step of voxel division is
a step in which the work is represented by a set of voxels before division and divided voxels, or by a set of voxels before division and polygons and voxels after division, by moving the tool according to the step of tool movement and dividing a voxel interfering with the tool;
the step of voxel removal is
a step in which voxels and polygons cut and removed by movement of the tool by the step of tool movement are detected and removed from the work wherein voxels were divided in the step of voxel division;
the step of polygonization is
a step in which voxels and polygons cut by movement of the tool in the step of tool movement are detected from a work according to voxels and polygons remaining from the step of voxel removal, and a form of the detected voxels and polygons after cutting according to the step of tool movement is represented and replaced by polygons; and
the step of display is
a step in which the work according to the voxels and the polygons is displayed.

4. A Medium recording a program for simulation method of cutting processing which displays a form of a work that sequentially changes by cutting processing based on data of a tool locus,
the program cyclically repeating in sequence:
a step of tool movement; a step of voxel division; a step of voxel removal; a step of polygonization; and a step of displaying, wherein:
the step of tool movement is
a step in which a tool is moved by only a predetermined distance for a work represented by a voxel, or a work represented by a voxel and a polygon, based on data of the tool locus;
the step of voxel division is
a step in which the work is represented by a set of voxels before division and divided voxels, or by a set of voxels before division and polygons and voxels after division, by moving the tool according to the step of tool movement and dividing a voxel interfering with the tool;
the step of voxel removal is
a step in which voxels and polygons cut and removed by movement of the tool by the step of tool movement are detected and removed from the work wherein voxels were divided in the step of voxel division;
the step of polygonization is
a step in which voxels and polygons cut by movement of the tool in the step of tool movement are detected from a work according to voxels and polygons remaining from the step of voxel removal, and a form of the detected voxels and polygons after cutting according to the step of tool movement is represented and replaced by polygons; and
the step of display is
a step in which the work according to the voxels and the polygons is displayed.

5. A modeling method of creating a three-dimensional form actuated by an operation of a user, wherein:
according to a step of initialization, an input of a form of a target of processing is accepted, and the target of processing is represented by a voxel, or the target of processing is represented by a voxel and a polygon; and
a step of input acceptance, a step of voxel division, a step of voxel removal, and a step of polygonization are cyclically repeated in sequence, wherein:
the step of input acceptance is
a step in which a change of form of the target of processing is accepted by actuation in an operation of the user;
the step of voxel division is
a step in which the voxel of a portion related to a change is divided according to a change in form of the target of processing according to the step of input acceptance, and the target of processing is represented by a set of voxels before division and divided voxels, or by a set of voxels before division and polygons and voxels after division;
the step of voxel removal is
a step in which voxels and polygons that have become unnecessary are detected from the target of processing in which a voxel was divided in the step of voxel division, and removed by a change in form of the target of processing according to the step of input acceptance; and
the step of polygonization is
a step in which voxels and polygons changing in form according to a change in form of the target of processing according to the step of input acceptance are detected from the target of processing according to voxels and polygons remaining from the step of voxel removal, and a form of the detected voxels and polygons after the change of form is replaced to be represented by polygons.

6. A Program for modeling method of creating a three-dimensional form actuated by an operation of a user, wherein:
according to a step of initialization, an input of a form of a target of processing is accepted, and the target of processing is represented by a voxel, or the target of processing is represented by a voxel and a polygon; and
a step of input acceptance, a step of voxel division, a step of voxel removal, and a step of polygonization are cyclically repeated in sequence, wherein:
the step of input acceptance is a step in which a change of form of the target of processing is accepted by actuation in an operation of the user;
the step of voxel division is
a step in which the voxel of a portion related to a change is divided according to a change in form of the target of processing according to the step of input acceptance, and the target of processing is represented by a set of voxels before division and divided voxels, or by a set of voxels before division and polygons and voxels after division;
the step of voxel removal is
a step in which voxels and polygons that have become unnecessary are detected from the target of processing in which a voxel was divided in the step of voxel division, and removed by a change in form of the target of processing according to the step of input acceptance; and
the step of polygonization is
a step in which voxels and polygons changing in form according to a change in form of the target of processing according to the step of input acceptance are detected from the target of processing according to voxels and polygons remaining from the step of voxel removal, and a form of the detected voxels and polygons after the change of form is replaced to be represented by polygons.

7. A Medium recocording for a program for modeling method of creating a three-dimensional form actuated by an operation of a user, wherein:
According to a step of initialization, an input of a form of a target of processing is accepted, and the target of processing is represented by a voxel, or the target of processing is represented by a voxel and a polygon; and
a step of input acceptance, a step of voxel division, a step of voxel removal, and a step of polygonization are cyclically repeated in sequence, wherein:
the step of input acceptance is
a step in which a change of form of the target of processing is accepted by actuation in an operation of the user;
the step of voxel division is
a step in which the voxel of a portion related to a change is divided according to a change in form of the target of processing according to the step of input acceptance, and the target of processing is represented by a set of voxels before division and divided voxels, or by a set of voxels before division and polygons and voxels after division;
the step of voxel removal is
a step in which voxels and polygons that have become unnecessary are detected from the target of processing in which a voxel was divided in the step of voxel division, and removed by a change in form of the target of processing according to the step of input acceptance; and
the step of polygonization is
a step in which voxels and polygons changing in form according to a change in form of the target of processing according to the step of input acceptance are detected from the target of processing according to voxels and polygons remaining from the step of voxel removal, and a form of the detected voxels and polygons after the change of form is replaced to be represented by polygons.
